(19) United States
(12) Patent Application Publication
(10) Pub. No.: US 2025/0124916 A1
(43) Pub. Date: Apr. 17, 2025

(54) AUDIO PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yongsen Jiang, Beijing (CN); Shunping Ye, Beijing (CN)

(21) Appl. No.: 18/905,343

(22) Filed: Oct. 3, 2024

(30) Foreign Application Priority Data
Oct. 17, 2023 (CN) 202311346349.6

(51) Int. Cl. G10L 15/187; G10L 15/06

(52) U.S. Cl. CPC G10L 15/187; G10L 15/063

(57) ABSTRACT

Embodiments of the present disclosure provide an audio processing method and apparatus, an electronic device, and a storage medium. The method includes: obtaining first audio and first text corresponding to the first audio; predicting a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and correcting a neutral tone in the first pronunciation sequence by a second pronunciation prediction system, and/or correcting a third tone after tone sandhi in the first pronunciation sequence by a third pronunciation prediction system.

### CROSS-REFERENCE TO RELATED APPLICATION

This application claims priority to Chinese Application No. 202311346349.6 filed Oct. 17, 2023, the disclosure of which is incorporated herein by reference in its entirety.

### FIELD

The present disclosure relates to the field of audio processing, and in particular, to an audio processing method and apparatus, an electronic device, and a storage medium.

### BACKGROUND

In the field of natural language processing, it is often necessary to predict a pronunciation sequence for text, which may be a phoneme sequence or a Pinyin sequence. There may be a neutral tone or two consecutive third tones in the text, and an example of the two consecutive third tones may be: ni3 and hao3, where 3 indicates the third tone. For the two consecutive third tones in the text, given that the first third tone may not be pronounced as the original third tone after being subjected to tone sandhi in a real-world reading scenario, the first third tone is usually labeled as a third tone after tone sandhi in the pronunciation sequence. In the prior art, the prediction of the pronunciation sequence is subject to the neutral tone and two consecutive third tones in the text, resulting in low accuracy.

### SUMMARY

Embodiments of the present disclosure provide an audio processing method and apparatus, an electronic device, and a storage medium, which can improve the accuracy of predicting a pronunciation sequence for text.

According to a first aspect, an embodiment of the present disclosure provides an audio processing method. The method includes:
obtaining first audio and first text corresponding to the first audio;
predicting a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and
correcting a neutral tone in the first pronunciation sequence by a second pronunciation prediction system, and/or correcting a third tone after tone sandhi in the first pronunciation sequence by a third pronunciation prediction system.

According to a second aspect, an embodiment of the present disclosure provides an audio processing apparatus. The apparatus includes:
a data obtaining unit configured to obtain first audio and first text corresponding to the first audio;
a pronunciation prediction unit configured to predict a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and
a pronunciation correction unit configured to correct a neutral tone in the first pronunciation sequence by a second pronunciation prediction system, and/or correct a third tone after tone sandhi in the first pronunciation sequence by a third pronunciation prediction system.

According to a third aspect, an embodiment of the present disclosure provides an electronic device. The electronic device includes: a processor; and a memory configured to store computer-executable instructions that, when executed, cause the processor to implement the steps of the method according to the first aspect.

According to a fourth aspect, an embodiment of the present disclosure provides a computer-readable storage medium for storing computer-executable instructions that, when executed by a processor, cause the steps of the method according to the first aspect to be implemented.

In one or more embodiments of the present disclosure, the first audio and the first text corresponding to the first audio are obtained; the first pronunciation sequence is predicted for the first text by the first pronunciation prediction system based on the first audio and the first text, where the tones of the pronunciations of the characters in the first text that are labeled in the first pronunciation sequence include the neutral tones and/or the third tones after tone sandhi, and the first third tone in the two consecutive third tones in the first text is labeled as the third tone after tone sandhi in the first pronunciation sequence; and the neutral tone in the first pronunciation sequence is corrected by the second pronunciation prediction system, and/or the third tone after tone sandhi in the first pronunciation sequence is corrected by the third pronunciation prediction system. It can be learned that with this embodiment, the first pronunciation sequence can be predicted for the first text, and further, the neutral tone in the first pronunciation sequence can be corrected, and/or the third tone after tone sandhi in the first pronunciation sequence can be corrected, which improves the accuracy of predicting the neutral tone and two consecutive third tones for text, and thus improves the accuracy of predicting a pronunciation sequence for the text.

### BRIEF DESCRIPTION OF THE DRAWINGS

In order to more clearly describe the technical solutions in the one or more embodiments of the present disclosure or in the prior art, the accompanying drawings for describing the embodiments or the prior art will be briefly described below. Apparently, the accompanying drawings in the description below show merely some embodiments recited in the present disclosure, and those of ordinary skill in the art may still derive other accompanying drawings from these accompanying drawings without creative efforts.

FIG. 1 is a schematic flowchart of an audio processing method according to an embodiment of the present disclosure;

FIG. 2 is a schematic diagram of the principle of pronunciation prediction by a first pronunciation prediction system according to an embodiment of the present disclosure;

FIG. 3 is a schematic diagram of the principle of pronunciation prediction by a second pronunciation prediction system according to an embodiment of the present disclosure;

FIG. 4 is a schematic diagram of the principle of pronunciation prediction by a third pronunciation prediction system according to an embodiment of the present disclosure;

FIG. 5 is a schematic diagram of a structure of an audio processing apparatus according to an embodiment of the present disclosure; and

FIG. 6 is a schematic diagram of a structure of an electronic device according to an embodiment of the present disclosure.

### DETAILED DESCRIPTION OF EMBODIMENTS

In order to make those skilled in the art better understand the technical solutions in the one or more embodiments of the present disclosure, the technical solutions in the one or more embodiments of the present disclosure will be clearly and completely described below with reference to the accompanying drawings in the one or more embodiments of the present disclosure. Apparently, the described embodiments are merely some rather than all of the embodiments of the present disclosure. All other embodiments obtained by those of ordinary skill in the art based on the one or more embodiments of the present disclosure without creative efforts shall fall within the scope of protection of the present disclosure.

An embodiment of the present disclosure provides an audio processing method, which can improve the accuracy of predicting a pronunciation sequence for text. In various embodiments of the present disclosure, a pronunciation may be represented by Pinyin or phonemes. Pronunciations of all characters in a piece of text constitute a pronunciation sequence for the text. A pronunciation has tones, which at least include a first (flat) tone, a second (rising) tone, a third (dipping) tone, and a fourth (falling) tone in Pinyin. In the pronunciation sequence, the first, second, third, and fourth tones may be represented by numbers 1, 2, 3, and 4, respectively. Herein, a specific example is given to explain the pronunciation, the pronunciation sequence, and the tones. In the specific example, text is “ [symbol] ”, and a pronunciation sequence for the text is: ni3, hao3, where “ni3” is a pronunciation of “ [symbol] ”, “hao3” is a pronunciation of “ [symbol] ”, and the number 3 indicates that a tone of the pronunciation is a third tone.

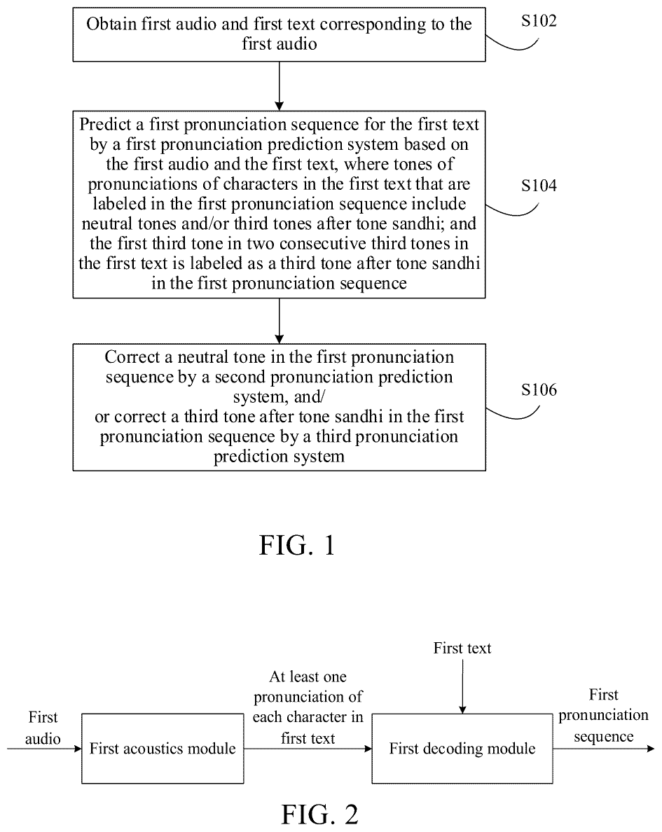

FIG. 1 is a schematic flowchart of an audio processing method according to an embodiment of the present disclosure. As shown in FIG. 1, the method includes:
step S102: obtaining first audio and first text corresponding to the first audio;
step S104: predicting a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and
step S106: correcting a neutral tone in the first pronunciation sequence by a second pronunciation prediction system, and/or correcting a third tone after tone sandhi in the first pronunciation sequence by a third pronunciation prediction system.

In this embodiment, the first audio and the first text corresponding to the first audio are obtained; the first pronunciation sequence is predicted for the first text by the first pronunciation prediction system based on the first audio and the first text, where the tones of the pronunciations of the characters in the first text that are labeled in the first pronunciation sequence include the neutral tones and/or the third tones after tone sandhi, and the first third tone in the two consecutive third tones in the first text is labeled as the third tone after tone sandhi in the first pronunciation sequence; and the neutral tone in the first pronunciation sequence is corrected by the second pronunciation prediction system, and/or the third tone after tone sandhi in the first pronunciation sequence is corrected by the third pronunciation prediction system. It can be learned that with this embodiment, the first pronunciation sequence can be predicted for the first text, and further, the neutral tone in the first pronunciation sequence can be corrected, and/or the third tone after tone sandhi in the first pronunciation sequence can be corrected, which improves the accuracy of predicting the neutral tone and two consecutive third tones for text, and thus improves the accuracy of predicting a pronunciation sequence for the text.

In step S102 above, the first audio and the first text corresponding to the first audio are obtained. In an embodiment, the first text may be obtained first, where the first text may be a passage, an article, and any other text, for which a pronunciation sequence needs to be predicted; and the first audio corresponding to the first text may then be obtained by reading the first text by a person. Certainly, the first audio corresponding to the first text may also be obtained in other manners, for example, based on a neural network, which is not limited in this embodiment. Alternatively, in other embodiments, the first audio may be obtained first, and the first text corresponding to the first audio may then be obtained through human transcription or a neural network, which is not limited herein.

In step S104 above, the first pronunciation sequence is predicted for the first text by the first pronunciation prediction system based on the first audio and the first text. The first pronunciation prediction system includes, but is not limited to, a grapheme-to-phoneme alignment system. The grapheme-to-phoneme alignment system includes, but is not limited to, a grapheme-to-phoneme (G2P) model. The first audio and the first text are input into the first pronunciation prediction system. The first pronunciation prediction system processes the first audio and the first text, to obtain the first pronunciation sequence for the first text. The pronunciation of each character in the first text is labeled in the first pronunciation sequence, and may be represented by Pinyin or phonemes. The first pronunciation sequence for the first text includes a Pinyin sequence or phoneme sequence for the first text.

In the first pronunciation sequence, the pronunciation has tones. In addition to the first, second, third, and fourth tones described above, the tones of the pronunciations of the characters in the first text that are labeled in the first pronunciation sequence include neutral tones and/or third tones after tone sandhi. In an embodiment, in addition to the first, second, third, and fourth tones described above, the tones of the pronunciations of the characters in the first text that are labeled in the first pronunciation sequence include neutral tones. In another embodiment, in addition to the first, second, third, and fourth tones described above, the tones of the pronunciations of the characters in the first text that are labeled in the first pronunciation sequence include third tones after tone sandhi. In still another embodiment, in addition to the first, second, third, and fourth tones described above, the tones of the pronunciations of the characters in the first text that are labeled in the first pronunciation sequence include both neutral tones and third tones after tone sandhi.

For some modal particles such as “ [symbol] (ya)”, “ [symbol] (wa)”, and “ [symbol] (ne)”, tones of their corresponding pronunciations are neutral tones, and in the first pronunciation sequence, the neutral tones may be represented by a number 5. Therefore, the pronunciations of the above modal particles may be “ya5”, “wa5”, and “ne5”, respectively.

For a word in the first text that has two consecutive third-tone characters, such as a word “ [symbol] ”, its corresponding pronunciation sequence may be “zhe3, li3”, indicating two consecutive third tones. However, given that a first third tone may not be pronounced as the original third tone after being subjected to tone sandhi in a real-world reading scenario, a tone for the first third-tone character in the two consecutive third-tone characters in the first text is labeled as a third tone after tone sandhi in the first pronunciation sequence, and the third tone after tone sandhi may be represented by a number 6. Therefore, in the first pronunciation sequence, the pronunciation sequence corresponding to the word “ [symbol] ” may be “zhe6, li3”.

In step S106 above, the neutral tone in the first pronunciation sequence is corrected by the second pronunciation prediction system, and/or the third tone after tone sandhi in the first pronunciation sequence is corrected by the third pronunciation prediction system.

In an embodiment, the neutral tone in the first pronunciation sequence is corrected by the second pronunciation prediction system. In another embodiment, the third tone after tone sandhi in the first pronunciation sequence is corrected by the third pronunciation prediction system. In still another embodiment, the neutral tone in the first pronunciation sequence is corrected by the second pronunciation prediction system, and the third tone after tone sandhi in the first pronunciation sequence is corrected by the third pronunciation prediction system.

It can be learned that with the procedure in FIG. 1, the first pronunciation sequence can be predicted for the first text, and further, the neutral tone in the first pronunciation sequence can be corrected, and/or the third tone after tone sandhi in the first pronunciation sequence can be corrected, which improves the accuracy of predicting the neutral tone and two consecutive third tones for text, and thus improves the accuracy of predicting a pronunciation sequence for the text.

In an embodiment, the predicting the first pronunciation sequence for the first text by the first pronunciation prediction system based on the first audio and the first text includes: predicting at least one pronunciation of each character in the first text by a first acoustics module in the first pronunciation prediction system based on the first audio, where a tone of the pronunciation includes a neutral tone and/or a third tone after tone sandhi;
selecting, by a first decoding module in the first pronunciation prediction system and based on the first text, a first target pronunciation for each character in the first text from the at least one predicted pronunciation of the character in the first text; and
generating the first pronunciation sequence by the first decoding module based on the first target pronunciation.

FIG. 2 is a schematic diagram of principle of pronunciation prediction by a first pronunciation prediction system according to an embodiment of the present disclosure. As shown in FIG. 2, the first pronunciation prediction system includes a first acoustics module and a first decoding module. The first acoustics module includes a plurality of transformers (which are attention mechanism-based neural networks). The first decoding module may include a plurality of convolutional networks. In this embodiment, the first audio is input into the first acoustics module, and the first acoustics module processes the first audio, to obtain at least one pronunciation for each character in the first text. The pronunciation includes a tone, including a neutral tone and/or a third tone after tone sandhi, that is, the tone of the pronunciation includes a neutral tone, or a third tone after tone sandhi, or both a neutral tone and a third tone after tone sandhi. The pronunciation may be represented by Pinyin or phonemes. Then, the first text is input into the first decoding module, and the first decoding module compares each character in the first text with each pronunciation of the character in the first text, to determine a matching degree between each character in the first text and each pronunciation of the character in the first text. A higher matching degree indicates a better match between the character and the pronunciation. The matching degree may be determined according to a graph-based shortest-path search algorithm. Next, the first decoding module selects, based on the matching degree and from each pronunciation of each character in the first text, a pronunciation with the highest matching degree for each character in the first text as a first target pronunciation of the character in the first text. A tone of the first target pronunciation includes a neutral tone and/or a third tone after tone sandhi, that is, the tone of the first target pronunciation includes a neutral tone, or a third tone after tone sandhi, or both a neutral tone and a third tone after tone sandhi. Finally, the first decoding module generates a first pronunciation sequence based on the first target pronunciation of each character in the first text, where the first pronunciation sequence includes the first target pronunciation of each character in the first text.

It can be learned that with this embodiment, the first acoustics module can predict the at least one pronunciation of each character in the first text based on the first audio, and the first decoding module can select, based on the first text, the first target pronunciation for each character in the first text from the at least one predicted pronunciation of each character in the first text, and generate the first pronunciation sequence based on the first target pronunciation, so that the first pronunciation sequence can be predicted for the first text efficiently and quickly.

In an embodiment, the correcting the neutral tone in the first pronunciation sequence by the second pronunciation prediction system includes:
predicting a second pronunciation sequence for the first text by the second pronunciation prediction system based on the first audio and the first text, where the second pronunciation sequence is used to label the tones of the pronunciations of the characters in the first text as neutral tones or non-neutral tones; and
correcting the neutral tone in the first pronunciation sequence based on the second pronunciation sequence.

In this embodiment, first, the first audio and the first text are input into the second pronunciation prediction system, and the second pronunciation prediction system may predict the second pronunciation sequence for the first text based on the first audio and the first text. The second pronunciation sequence is used to label the tones of the pronunciations of the characters in the first text as neutral tones or non-neutral tones. For example, the second pronunciation sequence has a label for each character in the first text, where a label 1 indicates that a tone of a pronunciation of the character is a neutral tone, and a label 0 indicates that a tone of the pronunciation of the character is a non-neutral tone. The non-neutral tone refers to tones other than the neutral tone, including the first, second, third, and fourth tones and the third tone after tone sandhi. Then, the neutral tone in the first pronunciation sequence is corrected based on the second pronunciation sequence.

It can be learned that with this embodiment, the second pronunciation prediction system can predict the second pronunciation sequence for the first text, where the second pronunciation sequence is used to label the tones of the pronunciations of the characters in the first text as neutral tones or non-neutral tones, and the second pronunciation prediction system can correct the neutral tone in the first pronunciation sequence based on the second pronunciation sequence, which improves the accuracy of predicting the neutral tone for text, and thus improves the accuracy of predicting a pronunciation sequence for the text.

In an embodiment, the predicting the second pronunciation sequence for the first text by the second pronunciation prediction system based on the first audio and the first text includes: predicting, by a second acoustics module in the second pronunciation prediction system and based on the first audio, a probability that a tone of a pronunciation of each character in the first text is a neutral tone;
determining, by a second decoding module in the second pronunciation prediction system and based on the first text and the predicted probability that a tone of a pronunciation of each character in the first text is a neutral tone, that the tone of the pronunciation of each character in the first text is a neutral tone or a non-neutral tone; and
generating the second pronunciation sequence by the second decoding module based on a determination result.

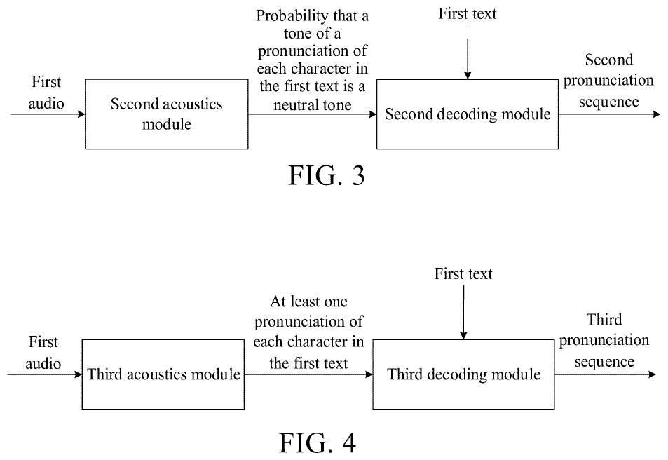

FIG. 3 is a schematic diagram of principle of pronunciation prediction by a second pronunciation prediction system according to an embodiment of the present disclosure. As shown in FIG. 3, the second pronunciation prediction system includes a second acoustics module and a second decoding module. The second acoustics module includes a plurality of transformers (which are attention mechanism-based neural networks). The second decoding module may include a plurality of convolutional networks. In this embodiment, the first audio is input into the second acoustics module, and the second acoustics module processes the first audio, to obtain the probability that the tone of the pronunciation of each character in the first text is a neutral tone. Then, the first text is input into the second decoding module, and the second decoding module determines, based on the first text and the predicted probability that the tone of the pronunciation of each character in the first text is a neutral tone, that the tone of the pronunciation of each character in the first text is a neutral tone or a non-neutral tone. In an example, the second decoding module analyzes each character in the first text, to determine whether the character is in a preset set of neutral-tone characters. For any character in the first text, if a probability that a tone of a pronunciation of the character is a neutral tone is greater than or equal to a preset probability threshold, and the character is in the preset set of neutral-tone characters, it is determined that the tone of the pronunciation of the character is a neutral tone; or if a probability that a tone of a pronunciation of the character is a neutral tone is less than a preset probability threshold, or the character is not in the preset set of neutral-tone characters, it is determined that the tone of the pronunciation of the character is a non-neutral tone.

Finally, the second decoding module determines a label for each character based on a determination result. A character with a tone of a pronunciation determined as a neutral tone may be set with a label equal to 1, and a character with a tone of a pronunciation determined as a non-neutral tone may be set with a label equal to 0. The second decoding module generates a second pronunciation sequence based on the label for each character, where the second pronunciation sequence has a label for each character in the first text.

It can be learned that with this embodiment, the second acoustics module can predict, based on the first audio, the probability that the tone of the pronunciation of each character in the first text is a neutral tone, and the second decoding module can determine, based on the first text and the predicted probability that the tone of the pronunciation of each character in the first text is a neutral tone, that the tone of the pronunciation of each character in the first text is a neutral tone or a non-neutral tone, and generate the second pronunciation sequence efficiently and quickly based on the determination result, so that a neutral tone in the first pronunciation sequence may be corrected.

In an embodiment, the correcting the neutral tone in the first pronunciation sequence based on the second pronunciation sequence includes:
determining whether a tone of a pronunciation of a first character in the first text in the first pronunciation sequence is labeled as a neutral tone or a non-neutral tone, where a tone of the pronunciation of the first character in the second pronunciation sequence is labeled as a neutral tone; and
if the tone of the pronunciation of the first character in the first pronunciation sequence is labeled as a neutral tone, keeping the tone of the pronunciation of the first character in the first pronunciation sequence unchanged; or
if the tone of the pronunciation of the first character in the first pronunciation sequence is labeled as a non-neutral tone, correcting the tone of the pronunciation of the first character in the first pronunciation sequence to a neutral tone.

In this embodiment, the first character is first determined in the first text, where the first character is a character with a tone of a pronunciation labeled as a neutral tone in the second pronunciation sequence. There may be one or more first characters. For each first character, it is determined whether the tone of the pronunciation of the first character in the first pronunciation sequence is labeled as a neutral tone or a non-neutral tone. If the tone of the pronunciation of the first character in the first pronunciation sequence is labeled as a neutral tone, the tone of the pronunciation of the first character in the first pronunciation sequence is kept unchanged. If the tone of the pronunciation of the first character in the first pronunciation sequence is labeled as a non-neutral tone, the tone of the pronunciation of the first character in the first pronunciation sequence is corrected to a neutral tone.

For example, for a first character with a tone of a pronunciation labeled as a neutral tone in the second pronunciation sequence, if the tone of the pronunciation of the first character in the first pronunciation sequence is labeled as a neutral tone, the tone of the pronunciation of the first character in the first pronunciation sequence is kept unchanged; or if the tone of the pronunciation of the first character in the first pronunciation sequence is labeled as a non-neutral tone, the tone of the pronunciation of the first character in the first pronunciation sequence is corrected to a neutral tone.

It can be learned that with this embodiment, the first character with the tone of the pronunciation labeled as a neutral tone in the second pronunciation sequence can be identified in the first text, and the tones of the pronunciation of the first character in the first pronunciation sequence are uniformly corrected to a neutral tone by taking the second pronunciation sequence as a criterion, thereby correcting the neutral tone in the first pronunciation sequence, which improves the accuracy of predicting the neutral tone for text, and thus improves the accuracy of predicting a pronunciation sequence for the text.

In an embodiment, the correcting the third tone after tone sandhi in the first pronunciation sequence by the third pronunciation prediction system includes:
predicting a third pronunciation sequence for the first text by the third pronunciation prediction system based on the first audio and the first text, where the third pronunciation sequence is used to label the first third tone in the two consecutive third tones in the first text with a second tone; and
correcting the third tone after tone sandhi in the first pronunciation sequence based on the third pronunciation sequence.

In this embodiment, first, the first audio and the first text are input into the third pronunciation prediction system, and the third pronunciation prediction system may predict the third pronunciation sequence for the first text based on the first audio and the first text, where the third pronunciation sequence is used to label the first third tone in two consecutive third tones in the first text with the second tone. For example, the first third tone in the two consecutive third tones in the first text is labeled with a number 2 in the third pronunciation sequence.

In a specific example, for a word in the first text that has two consecutive third-tone characters, such as a word “ [symbol] ”, its corresponding pronunciation sequence may be “zhe3, li3”, indicating two consecutive third tones. However, given that a first third tone may not be pronounced as the original third tone after being subjected to tone sandhi in a real-world reading scenario, a tone of the first third-tone character in the two consecutive third-tone characters in the first text is labeled as a second tone in the third pronunciation sequence. Therefore, in the third pronunciation sequence, the pronunciation sequence corresponding to the word “ [symbol] ” may be “zhe2, li3”.

Then, the third tone after tone sandhi in the first pronunciation sequence is corrected based on the third pronunciation sequence.

It can be learned that with this embodiment, the third pronunciation prediction system can predict the third pronunciation sequence for the first text, where the third pronunciation sequence is used to label the first third tone in two consecutive third tones in the first text with the second tone, and the third pronunciation prediction system can correct the third tone after tone sandhi in the first pronunciation sequence based on the third pronunciation sequence, which improves the accuracy of predicting the two consecutive third tones for text, and thus improves the accuracy of predicting a pronunciation sequence for the text.

In an embodiment, the predicting the third pronunciation sequence for the first text by the third pronunciation prediction system based on the first audio and the first text includes: predicting at least one pronunciation of each character in the first text by a third acoustics module in the third pronunciation prediction system based on the first audio, where a tone of the pronunciation includes a second tone corresponding to the first third tone in two consecutive third tones;
selecting, by a third decoding module in the third pronunciation prediction system and based on the first text, a second target pronunciation for each character in the first text from the at least one predicted pronunciation of each character in the first text; and
generating the third pronunciation sequence by the third decoding module based on the second target pronunciation.

FIG. 4 is a schematic diagram of principle of pronunciation prediction by a third pronunciation prediction system according to an embodiment of the present disclosure. As shown in FIG. 4, the third pronunciation prediction system includes a third acoustics module and a third decoding module. The third acoustics module includes a plurality of transformers (which are attention mechanism-based neural networks). The third decoding module may include a plurality of convolutional networks. In this embodiment, the first audio is input into the third acoustics module, and the third acoustics module processes the first audio, to obtain at least one pronunciation of each character in the first text. The pronunciation includes a tone, including a second tone corresponding to a first third tone in two consecutive third tones. The pronunciation may be represented by Pinyin or phonemes. Then, the first text is input into the third decoding module, and the third decoding module compares each character in the first text with each pronunciation of the character in the first text, to determine a matching degree between each character in the first text and each pronunciation of the character in the first text. A higher matching degree indicates a better match between the character and the pronunciation. The matching degree may be determined according to a graph-based shortest-path search algorithm. Next, the third decoding module selects, based on the matching degree and from each pronunciation of each character in the first text, a pronunciation with the highest matching degree for each character in the first text as a second target pronunciation of each character in the first text. A tone of the second target pronunciation includes a second tone corresponding to the first third tone in two consecutive third tones. Finally, the third decoding module generates a third pronunciation sequence based on the second target pronunciation of each character in the first text, where the third pronunciation sequence includes the second target pronunciation of each character in the first text.

It can be learned that with this embodiment, the third acoustics module can predict the at least one pronunciation of each character in the first text based on the first audio, and the third decoding module can select, based on the first text, the second target pronunciation for each character in the first text from the at least one predicted pronunciation of each character in the first text, and generate the third pronunciation sequence based on the second target pronunciation, so that the third pronunciation sequence can be predicted for the first text efficiently and quickly.

It can be learned from the foregoing description that the first pronunciation prediction system, the second pronunciation prediction system, and the third pronunciation prediction system are similar in structure but different in function. The reason for such a difference is that the systems are different in training data and training process. The training data and training process of the systems will be described later.

In an embodiment, the correcting the third tone after tone sandhi in the first pronunciation sequence based on the third pronunciation sequence includes:
determining whether a tone of a pronunciation of a second character in the first text in the third pronunciation sequence is labeled as a second tone, where a tone of the pronunciation of the second character in the first pronunciation sequence is labeled as a third tone after tone sandhi; and
if the tone of the pronunciation of the second character in the first pronunciation sequence is labeled as a second tone, keeping the tone of the pronunciation of the second character in the first pronunciation sequence unchanged; or
if the tone of the pronunciation of the second character in the first pronunciation sequence is not labeled as a second tone, modifying the tone of the pronunciation of the second character in the first pronunciation sequence based on the tone of the pronunciation of the second character in the third pronunciation sequence.

In this embodiment, the second character is first determined in the first text, where the second character is a character with a tone of a pronunciation labeled as a third tone after tone sandhi (which may be represented by the number 6) in the first pronunciation sequence. There may be one or more second characters. For each second character, it is determined whether the tone of the pronunciation of the second character in the third pronunciation sequence is labeled as a second tone. If the tone of the pronunciation of the second character in the third pronunciation sequence is labeled as a second tone, the tone of the pronunciation of the second character in the first pronunciation sequence is kept unchanged. If the tone of the pronunciation of the second character in the third pronunciation sequence is not labeled as a second tone, the tone of the pronunciation of the second character in the first pronunciation sequence is modified based on the tone of the pronunciation of the second character in the third pronunciation sequence, that is, the tone of the pronunciation of the second character in the first pronunciation sequence is modified to the tone of the pronunciation of the second character in the third pronunciation sequence.

For example, for a second character with a tone of a pronunciation labeled as a third tone 6 after tone sandhi in the first pronunciation sequence, if a tone of the pronunciation of the second character in the third pronunciation sequence is labeled as a second tone 2, the tone 6 of the pronunciation of the second character in the first pronunciation sequence is kept unchanged; or if the tone of the pronunciation of the second character in the third pronunciation sequence is not labeled as a second tone 2, the tone 6 of the pronunciation of the second character in the first pronunciation sequence is modified to the tone of the pronunciation of the second character in the third pronunciation sequence.

It can be learned that with this embodiment, the second character can be identified in the first text, which second character is a character with a tone of a pronunciation labeled as a third tone after tone sandhi in the first pronunciation sequence, and if the tone of the pronunciation of the second character in the third pronunciation sequence is not labeled as a second tone, the tone of the pronunciation of the second character in the first pronunciation sequence is modified based on the tone of the pronunciation of the second character in the third pronunciation sequence, thereby correcting the third tone after tone sandhi in the first pronunciation sequence, which improves the accuracy of predicting the two consecutive third tones for text, and thus improves the accuracy of predicting a pronunciation sequence for the text.

In still another embodiment, the correcting the third tone after tone sandhi in the first pronunciation sequence based on the third pronunciation sequence includes:
determining whether a tone of a pronunciation of a third character in the first text in the first pronunciation sequence is labeled as a third tone after tone sandhi, where a tone of the pronunciation of the third character in the third pronunciation sequence is labeled as a second tone corresponding to the first third tone in two consecutive third tones; and
if the tone of the pronunciation of the third character in the first pronunciation sequence is labeled as a third tone after tone sandhi, keeping the tone of the pronunciation of the third character in the first pronunciation sequence unchanged; or
if the tone of the pronunciation of the third character in the first pronunciation sequence is not labeled as a third tone after tone sandhi, modifying the tone of the pronunciation of the third character in the first pronunciation sequence to a third tone after tone sandhi.

In this embodiment, the third character is first determined in the first text, where the third character is a character with a tone of a pronunciation labeled as a second tone corresponding to the first third tone in two consecutive third tones (which may be represented by the number 2) in the third pronunciation sequence. For example, all second tones are identified in the third pronunciation sequence. If a next tone of an identified second tone is a third tone, it is determined that the second tone is the second tone corresponding to the first third tone in two consecutive third tones, and the second tone corresponds to a character in the first text that is the third character. There may be one or more third characters.

For each third character, it is determined whether the tone of the pronunciation of the third character in the first pronunciation sequence is labeled as a third tone after tone sandhi (which may be represented by the number 6). If the tone of the pronunciation of the third character in the first pronunciation sequence is labeled as a third tone after tone sandhi, the tone of the pronunciation of the third character in the first pronunciation sequence is kept unchanged. If the tone of the pronunciation of the third character in the first pronunciation sequence is not labeled as a third tone 6 after tone sandhi, the tone of the pronunciation of the third character in the first pronunciation sequence is modified to a third tone 6 after tone sandhi.

For example, for a third character, a tone of a pronunciation of the third character in the third pronunciation sequence is labeled as a second tone 2, and a tone of a next character of the third character in the third pronunciation sequence is a third tone 3. If the tone of the pronunciation of the third character in the first pronunciation sequence is labeled as a third tone 6 after tone sandhi, the tone 6 of the pronunciation of the third character in the first pronunciation sequence is kept unchanged. If the tone of the pronunciation of the third character in the first pronunciation sequence is not labeled as a third tone 6 after tone sandhi, the tone of the pronunciation of the third character in the first pronunciation sequence is modified to a third tone 6 after tone sandhi.

It can be learned that with this embodiment, the third character can be identified in the first text, and if the tone of the pronunciation of the third character in the first pronunciation sequence is not labeled as a third tone after tone sandhi, the tone of the pronunciation of the third character in the first pronunciation sequence is modified to a third tone after tone sandhi, thereby correcting the third tone after tone sandhi in the first pronunciation sequence, which improves the accuracy of predicting the two consecutive third tones for text, and thus improves the accuracy of predicting a pronunciation sequence for the text.

The detailed process of the audio processing method is described above, and the training data and training process of the first pronunciation prediction system, the second pronunciation prediction system, and the third pronunciation prediction system will be described below.

In an embodiment, the method further includes:
obtaining first sample audio and a first sample pronunciation sequence corresponding to the first sample audio, where tones of pronunciations for the first sample audio in the first sample pronunciation sequence include neutral tones and/or third tones after tone sandhi; and the first third tone in two consecutive third tones for the first sample audio is labeled as a third tone after tone sandhi in the first sample pronunciation sequence;
determining a first time alignment relationship between each audio time frame in the first sample audio and each pronunciation in the first sample pronunciation sequence; and
training the first pronunciation prediction system based on the first time alignment relationship.

In this embodiment, first, the first sample audio and the first sample pronunciation sequence corresponding to the first sample audio are obtained. The first sample audio may be any audio used to train the first pronunciation prediction system. The first sample pronunciation sequence corresponding to the first sample audio is used to label the pronunciation of each character in the first sample audio, where the pronunciation has a tone, and may be represented by Pinyin or phonemes. The first sample pronunciation sequence may be a Pinyin sequence or a phoneme sequence. In the first sample pronunciation sequence, the tones of the pronunciations for the first sample audio include neutral tones and/or third tones after tone sandhi, that is, the tones of the pronunciations for the first sample audio include at least one of the neutral tones and the third tones after tone sandhi. Similar to the foregoing, the first third tone in two consecutive third tones in the first sample audio is labeled as a third tone after tone sandhi, for example, as a tone 6, in the first sample pronunciation sequence. The first sample pronunciation sequence corresponding to the first sample audio may be obtained by means of manual labeling, which is not limited in this embodiment.

Then, the first time alignment relationship between each audio time frame in the first sample audio and each pronunciation in the first sample pronunciation sequence may be determined using a Gaussian mixture model-hidden Markov model (GMM-HMM) neural network. The first time alignment relationship indicates a correspondence between a duration of each pronunciation in the first sample pronunciation sequence and each audio time frame in the first sample audio. For example, the first time alignment relationship indicates that a duration of a first pronunciation in the first sample pronunciation sequence corresponds to first and second audio time frames in the first sample audio, and a duration of a second pronunciation in the first sample pronunciation sequence corresponds to a third audio time frame in the first sample audio. Based on the first time correspondence, audio time frames in the first sample audio that respectively correspond to the pronunciations in the first sample pronunciation sequence can be determined.

Finally, the first pronunciation prediction system is trained based on the first time alignment relationship. In an embodiment, the first acoustics module in the first pronunciation prediction system may be trained based on the first time alignment relationship, so that based on a large amount of first sample audio and a large number of first sample pronunciation sequences corresponding to the first sample audio, the trained first acoustics module can learn audio time frames in the first sample audio that respectively correspond to the pronunciations in the first sample pronunciation sequence and learn features of different pronunciations, and therefore can predict a pronunciation corresponding to each time frame in audio and a tone of the pronunciation.

During the process of training the first acoustics module, when the first acoustics module learns the pronunciation corresponding to each audio time frame in the first sample audio, it will learn a plurality of pronunciation results and generate a probability value for each pronunciation result, which, in combination with the first time alignment relationship described above, may allow the first acoustics module to generate a maximum probability value for a correct pronunciation result. That is, a pronunciation result with the highest probability corresponding to each audio time frame, which is learned by the first acoustics module, is the correct pronunciation result. In this way, the training accuracy of the first acoustics module is improved.

For the first decoding module in the first pronunciation prediction system, reference may be made to a general training method, which is not limited in this embodiment.

It can be learned that with this embodiment, the first pronunciation prediction system can be trained based on the first sample audio and the first sample pronunciation sequence. Since the tones of the pronunciations for the first sample audio in the first sample pronunciation sequence include neutral tones and/or third tones after tone sandhi, the trained first pronunciation prediction system has an ability to predict a neutral tone and/or a third tone after tone sandhi for text. The first pronunciation prediction system is trained based on the first time alignment relationship, so that the pronunciation result with the highest probability, which is learned by the first pronunciation prediction system for each audio time frame, is the correct pronunciation result. In this way, the training accuracy of the first pronunciation prediction system is improved.

In an embodiment, the method further includes:
obtaining second sample audio and a second sample pronunciation sequence corresponding to the second sample audio, where the second sample pronunciation sequence is used to label a tone of each pronunciation for the second sample audio as a neutral tone or a non-neutral tone;
determining a second time alignment relationship between each audio time frame in the second sample audio and each pronunciation in the second sample pronunciation sequence; and
training the second pronunciation prediction system based on the second time alignment relationship.

In this embodiment, first, the second sample audio and the second sample pronunciation sequence corresponding to the second sample audio are obtained. The second sample audio may be any audio used to train the second pronunciation prediction system. The second sample pronunciation sequence corresponding to the second sample audio is used to label the tone of the pronunciation of each character in the second sample audio as a neutral tone or a non-neutral tone. For example, label 1 is used to indicate that the tone is a neutral tone, and label 0 is used to indicate that the tone is a non-neutral tone. The second sample pronunciation sequence corresponding to the second sample audio may be obtained by means of manual labeling, which is not limited in this embodiment. The second sample audio may be the same as or different from the first sample audio, which is not limited herein.

Then, the second time alignment relationship between each audio time frame in the second sample audio and each pronunciation in the second sample pronunciation sequence may be determined using the GMM-HMM neural network. The second time alignment relationship indicates a correspondence between a duration of each pronunciation in the second sample pronunciation sequence and each audio time frame in the second sample audio. For example, the second time alignment relationship indicates that a duration of a first pronunciation in the second sample pronunciation sequence corresponds to first and second audio time frames in the second sample audio, and a duration of a second pronunciation in the second sample pronunciation sequence corresponds to a third audio time frame in the second sample audio. Based on the second time correspondence, audio time frames in the second sample audio that respectively correspond to the pronunciations in the second sample pronunciation sequence can be determined.

Finally, the second pronunciation prediction system is trained based on the second time alignment relationship. In an embodiment, the second acoustics module in the second pronunciation prediction system may be trained based on the second time alignment relationship, so that based on a large amount of second sample audio and a large number of second sample pronunciation sequences corresponding to the second sample audio, the trained second acoustics module can learn audio time frames in the second sample audio that respectively correspond to the pronunciations in the second sample pronunciation sequence, and learn features of neutral tones and non-neutral tones, and therefore, it can be predicted whether a tone of a pronunciation corresponding to each time frame in an audio is a neutral tone.

For the second decoding module in the second pronunciation prediction system, reference may be made to a general training method, which is not limited in this embodiment.

It can be learned that with this embodiment, the second pronunciation prediction system can be trained based on the second sample audio and the second sample pronunciation sequence. Since the second sample pronunciation sequence is used to label a tone of each pronunciation in the second sample audio as a neutral tone or a non-neutral tone, the trained second pronunciation prediction system has an ability to predict whether a pronunciation for text is a neutral tone or a non-neutral tone, thus facilitating correction of a predicted neutral tone by the second pronunciation prediction system.

In an embodiment, the method further includes:
obtaining third sample audio and a third sample pronunciation sequence corresponding to the third sample audio, where the first third tone in two consecutive third tones for the third sample audio is labeled as a second tone in the third sample pronunciation sequence;
determining a third time alignment relationship between each audio time frame in the third sample audio and each pronunciation in the third sample pronunciation sequence; and
training the third pronunciation prediction system based on the third time alignment relationship.

In this embodiment, first, the third sample audio and the third sample pronunciation sequence corresponding to the third sample audio are obtained. The third sample audio may be any audio used to train the third pronunciation prediction system. The third sample pronunciation sequence corresponding to the third sample audio is used to label the pronunciation of each character in the third sample audio, where the pronunciation has a tone, and may be represented by Pinyin or phonemes. The third sample pronunciation sequence may be a Pinyin sequence or a phoneme sequence. The first third tone in two consecutive third tones in the third sample audio is labeled as a second tone, i.e., a tone 2, in the third sample pronunciation sequence, and therefore, in the third sample pronunciation sequence, the tones of the pronunciations for the third sample audio include the second tone corresponding to the first third tone in two consecutive third tones. The third sample pronunciation sequence corresponding to the third sample audio may be obtained by means of manual labeling. For example, first, the first sample pronunciation sequence corresponding to the first sample audio is obtained, and then the third tone after tone sandhi in the first sample pronunciation sequence is modified to the second tone, to obtain the third sample pronunciation sequence. In this case, the first sample audio is used as the third sample audio.

Then, the third time alignment relationship between each audio time frame in the third sample audio and each pronunciation in the third sample pronunciation sequence may be determined using the GMM-HMM neural network. The third time alignment relationship indicates a correspondence between a duration of each pronunciation in the third sample pronunciation sequence and each audio time frame in the third sample audio. For example, the third time alignment relationship indicates that a duration of a first pronunciation in the third sample pronunciation sequence corresponds to first and second audio time frames in the third sample audio, and a duration of a third pronunciation in the third sample pronunciation sequence corresponds to a third audio time frame in the third sample audio. Based on the third time correspondence, audio time frames in the third sample audio that respectively correspond to the pronunciations in the third sample pronunciation sequence can be determined.

Finally, the third pronunciation prediction system is trained based on the third time alignment relationship. In an embodiment, the third acoustics module in the third pronunciation prediction system may be trained based on the third time alignment relationship, so that based on a large amount of third sample audio and a large number of third sample pronunciation sequences corresponding to the third sample audio, the trained third acoustics module can learn audio time frames in the third sample audio that respectively correspond to the pronunciations in the third sample pronunciation sequence, and learn features of different pronunciations, and therefore can predict a pronunciation corresponding to each time frame in audio and a tone of the pronunciation.

During the process of training the third acoustics module, when the third acoustics module learns the pronunciation corresponding to each audio time frame in the third sample audio, it will learn a plurality of pronunciation results and generate a probability value for each pronunciation result, which, in combination with the third time alignment relationship described above, may allow the third acoustics module to generate a maximum probability value for a correct pronunciation result. That is, a pronunciation result with the highest probability corresponding to each audio time frame, which is learned by the third acoustics module, is the correct pronunciation result. In this way, the training accuracy of the third acoustics module is improved.

For the third decoding module in the third pronunciation prediction system, reference may be made to a general training method, which is not limited in this embodiment.

It can be learned that with this embodiment, the third pronunciation prediction system can be trained based on the third sample audio and the third sample pronunciation sequence. Since the first third tone in two consecutive third tones in the third sample audio is labeled as a second tone in the third sample pronunciation sequence, the trained third pronunciation prediction system has an ability to predict a first third tone in two consecutive third tones as a second tone, thus facilitating correction of a predicted third tone after tone sandhi by the third pronunciation prediction system.

In conclusion, with the audio processing method described above, the first pronunciation sequence can be predicted for the first text, and further, the neutral tone in the first pronunciation sequence can be corrected, and/or the third tone after tone sandhi in the first pronunciation sequence can be corrected, which improves the accuracy of predicting the neutral tone and two consecutive third tones for text, and thus improves the accuracy of predicting a pronunciation sequence for the text. Moreover, with the audio processing method described above, the first decoding module selects, based on the first text, a first target pronunciation for each character in the first text from the at least one predicted pronunciation of the character in the first text, in which case a text is compared with various possible pronunciations corresponding to the text, so that the accuracy of predicting a pronunciation of a polyphonic character can also be improved.

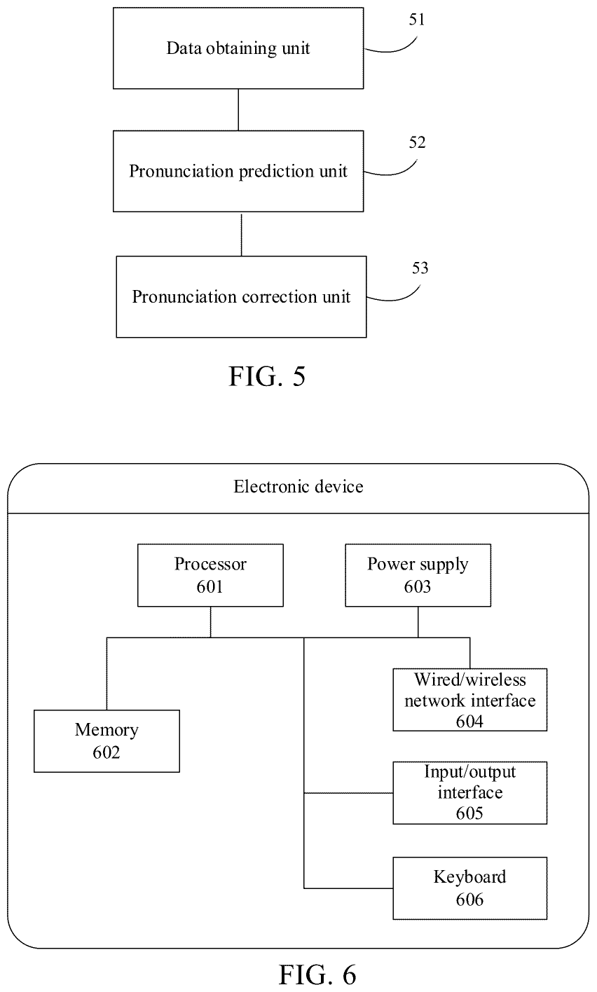

FIG. 5 is a schematic diagram of a structure of an audio processing apparatus according to an embodiment of the present disclosure. As shown in FIG. 5, the apparatus includes:
a data obtaining unit 51 configured to obtain first audio and first text corresponding to the first audio;
a pronunciation prediction unit 52 configured to predict a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and
a pronunciation correction unit 53 configured to correct a neutral tone in the first pronunciation sequence by a second pronunciation prediction system, and/or correct a third tone after tone sandhi in the first pronunciation sequence by a third pronunciation prediction system.

Optionally, the pronunciation prediction unit 52 is specifically configured to:
predict at least one pronunciation of each character in the first text by a first acoustics module in the first pronunciation prediction system based on the first audio, where a tone of the pronunciation includes a neutral tone and/or a third tone after tone sandhi;
select, by a first decoding module in the first pronunciation prediction system and based on the first text, a first target pronunciation for each character in the first text from the at least one predicted pronunciation of the character in the first text; and
generate the first pronunciation sequence by the first decoding module based on the first target pronunciation.

Optionally, the pronunciation correction unit 53 is specifically configured to:
predict a second pronunciation sequence for the first text by the second pronunciation prediction system based on the first audio and the first text, where the second pronunciation sequence is used to label the tones of the pronunciations of the characters in the first text as neutral tones or non-neutral tones; and
correct the neutral tone in the first pronunciation sequence based on the second pronunciation sequence.

Optionally, the pronunciation correction unit 53 is specifically configured to: predict a third pronunciation sequence for the first text by the third pronunciation prediction system based on the first audio and the first text, where the third pronunciation sequence is used to label the first third tone in the two consecutive third tones in the first text with a second tone; and correct the third tone after tone sandhi in the first pronunciation sequence based on the third pronunciation sequence.

Optionally, the pronunciation correction unit 53 is further specifically configured to: predict, by a second acoustics module in the second pronunciation prediction system and based on the first audio, a probability that a tone of a pronunciation of each character in the first text is a neutral tone;
determine, by a second decoding module in the second pronunciation prediction system and based on the first text and the predicted probability that a tone of a pronunciation of each character in the first text is a neutral tone, that the tone of the pronunciation of each character in the first text is a neutral tone or a non-neutral tone; and
generate the second pronunciation sequence by the second decoding module based on a determination result.

Optionally, the pronunciation correction unit 53 is further specifically configured to: determine whether a tone of a pronunciation of a first character in the first text in the first pronunciation sequence is labeled as a neutral tone or a non-neutral tone, where a tone of the pronunciation of the first character in the second pronunciation sequence is labeled as a neutral tone; and
in response to the tone of the pronunciation of the first character in the first pronunciation sequence being labeled as a neutral tone, keep the tone of the pronunciation of the first character in the first pronunciation sequence unchanged; or
in response to the tone of the pronunciation of the first character in the first pronunciation sequence being labeled as a non-neutral tone, correct the tone of the pronunciation of the first character in the first pronunciation sequence to a neutral tone.

Optionally, the pronunciation correction unit 53 is further specifically configured to:
predict at least one pronunciation of each character in the first text by a third acoustics module in the third pronunciation prediction system based on the first audio, where a tone of the pronunciation includes a second tone corresponding to the first third tone in two consecutive third tones;
select, by a third decoding module in the third pronunciation prediction system and based on the first text, a second target pronunciation for each character in the first text from the at least one predicted pronunciation of each character in the first text; and
generate the third pronunciation sequence by the third decoding module based on the second target pronunciation.

Optionally, the pronunciation correction unit 53 is further specifically configured to: determine whether a tone of a pronunciation of a second character in the first text in the third pronunciation sequence is labeled as a second tone, where a tone of the pronunciation of the second character in the first pronunciation sequence is labeled as a third tone after tone sandhi; and
in response to the tone of the pronunciation of the second character in the first pronunciation sequence being labeled as a second tone, keep the tone of the pronunciation of the second character in the first pronunciation sequence unchanged; or
in response to the tone of the pronunciation of the second character in the first pronunciation sequence not being labeled as a second tone, modify the tone of the pronunciation of the second character in the first pronunciation sequence based on the tone of the pronunciation of the second character in the third pronunciation sequence.

Optionally, the pronunciation correction unit 53 is further specifically configured to:
determine whether a tone of a pronunciation of a third character in the first text in the first pronunciation sequence is labeled as a third tone after tone sandhi, where a tone of the pronunciation of the third character in the third pronunciation sequence is labeled as a second tone corresponding to the first third tone in two consecutive third tones; and
in response to the tone of the pronunciation of the third character in the first pronunciation sequence being labeled as a third tone after tone sandhi, keep the tone of the pronunciation of the third character in the first pronunciation sequence unchanged; or
in response to the tone of the pronunciation of the third character in the first pronunciation sequence not being labeled as a third tone after tone sandhi, modify the tone of the pronunciation of the third character in the first pronunciation sequence to a third tone after tone sandhi.

Optionally, the apparatus further includes a first training unit configured to:
obtain first sample audio and a first sample pronunciation sequence corresponding to the first sample audio, where tones of pronunciations for the first sample audio in the first sample pronunciation sequence include neutral tones and/or third tones after tone sandhi; and the first third tone in two consecutive third tones for the first sample audio is labeled as a third tone after tone sandhi in the first sample pronunciation sequence;
determine a first time alignment relationship between each audio time frame in the first sample audio and each pronunciation in the first sample pronunciation sequence; and
train the first pronunciation prediction system based on the first time alignment relationship.

Optionally, the apparatus further includes a second training unit configured to: obtain second sample audio and a second sample pronunciation sequence corresponding to the second sample audio, where the second sample pronunciation sequence is used to label a tone of each pronunciation for the second sample audio as a neutral tone or a non-neutral tone; determine a second time alignment relationship between each audio time frame in the second sample audio and each pronunciation in the second sample pronunciation sequence; and train the second pronunciation prediction system based on the second time alignment relationship.

Optionally, the apparatus further includes a third training unit configured to: obtain third sample audio and a third sample pronunciation sequence corresponding to the third sample audio, where the first third tone in two consecutive third tones for the third sample audio is labeled as a second tone in the third sample pronunciation sequence;
determine a third time alignment relationship between each audio time frame in the third sample audio and each pronunciation in the third sample pronunciation sequence; and
train the third pronunciation prediction system based on the third time alignment relationship.

The audio processing apparatus in this embodiment of the present disclosure can implement various processes in the above audio processing method embodiment, and achieve the same effects and functions, which will not be repeated herein.

An embodiment of the present disclosure further provides an electronic device. FIG. 6 is a schematic diagram of a structure of an electronic device according to an embodiment of the present disclosure. As shown in FIG. 6, the electronic device may vary greatly depending on configurations or performance, and may include one or more processors 601 and memories 602. The memory 602 may store one or more applications or data. The memory 602 may be a temporary storage or a persistent storage. The applications stored in the memory 602 may include one or more modules (not shown in the figure), and each module may include a set of computer-executable instructions in the electronic device. Still further, the processor 601 may be configured to communicate with the memory 602 and execute, on the electronic device, the set of computer-executable instructions in the memory 602. The electronic device may further include one or more power supplies 603, one or more wired or wireless network interfaces 604, one or more input or output interfaces 605, one or more keyboards 606, etc.

In a specific embodiment, the electronic device includes: a processor; and a memory configured to store computer-executable instructions that, when executed, cause the processor to implement the following procedures:
obtaining first audio and first text corresponding to the first audio;
predicting a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and
correcting a neutral tone in the first pronunciation sequence by a second pronunciation prediction system, and/or correcting a third tone after tone sandhi in the first pronunciation sequence by a third pronunciation prediction system.

The electronic device in this embodiment of the present disclosure can implement various processes in the above audio processing method embodiment, and achieve the same effects and functions, which will not be repeated herein.

Another embodiment of the present disclosure further provides a computer-readable storage medium for storing computer-executable instructions that, when executed by a processor, cause the following procedures to be implemented:
obtaining first audio and first text corresponding to the first audio;
predicting a first pronunciation sequence for the first text by a first pronunciation prediction system based on the first audio and the first text, where tones of pronunciations of characters in the first text that are labeled in the first pronunciation sequence include neutral tones and/or third tones after tone sandhi; and the first third tone in two consecutive third tones in the first text is labeled as a third tone after tone sandhi in the first pronunciation sequence; and
correcting a neutral tone in the first pronunciation sequence by a second pronunciation prediction system, and/or correcting a third tone after tone sandhi in the first pronunciation sequence by a third pronunciation prediction system.

The storage medium in this embodiment of the present disclosure can implement various processes in the above audio processing method embodiment, and achieve same effects and functions, which will not be repeated herein.

In various embodiments of the present disclosure, the computer-readable storage medium includes a read-only memory (ROM), a random access memory (RAM), a magnetic disk, or an optical disk, etc.

In the 1990s, improvements to a technique can be clearly distinguished between hardware improvements (e.g., improvements to a circuit structure such as a diode, a transistor, and a switch) and software improvements (improvements to a method flow). However, with the development of technologies, currently, improvements to many procedures of methods may be regarded as direct improvements to hardware circuit structures. Almost all of the designers program an improved procedure of a method into a hardware circuit to obtain a corresponding hardware circuit structure. Therefore, it cannot be said that the improvement to a procedure of a method cannot be implemented by a hardware entity module. For example, a programmable logic device (PLD) (e.g., a field programmable gate array (FPGA)) is an integrated circuit, a logic function of which is determined by a user by programming the device. Designers perform programming by themselves to “integrate” a digital system onto a PLD without having to ask for a chip manufacturer to design and fabricate a specialized integrated circuit chip. Moreover, nowadays, instead of manually fabricating the integrated circuit chip, such programming is mostly implemented by using “logic compiler” software, which is similar to a software compiler used for program development and writing. Further, the original code before complication needs to be written in a specific programming language, which is called hardware description language (HDL). There are a plurality of HDLs, not just one, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Currently, the most commonly used HDLs are Very-High-Speed Integrated Circuit Hardware Description Language (VHDL) and Verilog. It shall also be understood by those skilled in the art that, a hardware circuit for implementing a logical procedure of a method can be easily obtained by simply logically programming the procedure of the method in the hardware description languages described above into an integrated circuit.

A controller may be implemented in any appropriate manner. For example, the controller may take the form of, for example, a microprocessor or a processor and a computer-readable medium storing computer-readable program code (such as software or firmware) executable by the (micro) processor, a logic gate, a switch, an application specific integrated circuit (ASIC), a programmable logic controller, and an embedded microcontroller. Examples of the controller include, but are not limited to, the following microcontrollers: ARC 625D, Atmel AT91SAM, Microchip PIC18F26K20 and Silicone Labs C8051F320. Further, a memory controller may be implemented as part of a control logic of the memory. It shall also be known by those skilled in the art that, in addition to implementing the controller solely in the form of computer-readable program code, it is absolutely possible to logically program the method steps to enable the controller to achieve the same functions in the form of a logic gate, a switch, an application specific integrated circuit, a programmable logic controller, an embedded microcontroller, etc. Therefore, such a controller can be regarded as a hardware component, and means included in the controller and used for implementing various functions may correspondingly be regarded as structures in the hardware component, or the means for implementing various functions may even be regarded as both software modules for implementing the method and structures in the hardware component.

Specifically, the systems, apparatuses, modules, or units set forth in the above embodiments may be implemented by a computer chip or entity, or may be implemented by a product with a certain function. A typical device for the implementation is a computer. Specifically, the computer may be, for example, a personal computer, a laptop computer, a cellular phone, a camera phone, a smart phone, a personal digital assistant, a media player, a navigation device, an e-mail device, a game console, a tablet computer, a wearable device, or a combination of any of these devices.

For ease of description, when described, the above apparatus is divided into various units based on functions. Certainly, functions of the units may be implemented in one or more pieces of software and/or hardware when the embodiments of the present disclosure are implemented.

It shall be understood by those skilled in the art that the one or more embodiments of the present disclosure may be provided as methods, systems, or computer program products. Thus, the one or more embodiment of the present disclosure may take the form of full hardware embodiments, full software embodiments, or embodiments with a combination of software and hardware. Furthermore, the one or more embodiments of the present disclosure may take the form of a computer program product that is implemented on one or more computer-usable storage media (including, but not limited to, a disk memory, a CD-ROM, an optical memory, etc.) that include computer-usable program code.

The present disclosure is described with reference to the flowcharts and/or the block diagrams of the method, the device (system), and the computer program product according to the embodiments of the present disclosure. It should be understood that each procedure and/or block in the flowcharts and/or block diagrams, and a combination of procedures and/or blocks in the flowcharts and/or block diagrams may be implemented by computer program instructions. These computer program instructions may be provided to a processor of a general-purpose computer, a special-purpose computer, an embedded processor or other programmable data processing devices to create a machine, such that the instructions executed by the processor of the computer or other programmable data processing devices create means for implementing functions specified in one or more procedures in the flowcharts and/or one or more blocks in the block diagrams.

These computer program instructions may also be stored in a computer-readable memory that may direct the computer or other programmable data processing devices to operate in a specific manner, such that the instructions stored in the computer-readable memory create an article of manufacture including instruction means, and the instruction means implements the functions specified in one or more procedures in the flowcharts and/or one or more blocks in the block diagrams.

These computer program instructions may also be loaded onto the computer or other programmable data processing devices, such that a series of operation steps are executed on the computer or other programmable devices to perform computer-implemented processing, and thus the instructions executed on the computer or other programmable devices provide steps for implementing the functions specified in one or more procedures in the flowcharts and/or one or more blocks in the block diagrams.

It should also be noted that, the terms “comprise”, “include”, or their any other variants are intended to cover a non-exclusive inclusion, so that a process, a method, a commodity, or a device that includes a list of elements not only includes those elements but also includes other elements which are not expressly listed, or further includes elements inherent to such a process, method, commodity, or device. In the absence of more restrictions, an element defined by “including a . . . ” does not exclude another identical element in a process, method, commodity, or device that includes the element.

The one or more embodiments of the present disclosure may be described in a general context of a computer executable instruction executed by a computer, for example, a program module. Generally, the program module includes a routine, a program, an object, a component, a data structure, etc., that performs a particular task or implements a particular abstract data type. The one or more embodiments of the present disclosure may also be practiced in distributed computing environments where a task is performed by a remote processing device that is connected over a communication network. In the distributed computing environments, the program module may be located in local and remote computer storage media, including a storage device.

All embodiments in the present disclosure are described in a progressive way, each embodiment focuses on the differences from the other embodiments, and reference may be made to each other for the same and similar parts among the embodiments. In particular, the system embodiment is substantially similar to the method embodiment, and is thus described in a simple manner, and for a related part, reference may be made to the part of the descriptions of the method embodiment.

The foregoing is only embodiments of the present disclosure, and is not intended to limit the present disclosure. For those skilled in the art, various variations and changes may be made to the present disclosure. Any modifications, equivalent substitutions, improvements, etc. made within the spirit and principle of the present disclosure shall be included within the scope of the claims of the present disclosure.

I/We claim:

1. An audio processing method, comprising:
obtaining first audio and first text corresponding to the first audio;
predicting a first pronunciation sequence for the first text by a first pronunciation prediction system based on the first audio and the first text, wherein tones of pronunciations of characters in the first text that are labeled in the first pronunciation sequence comprise neutral tones and/or third tones after tone sandhi; and the first third tone in two consecutive third tones in the first text is labeled as a third tone after tone sandhi in the first pronunciation sequence; and
correcting a neutral tone in the first pronunciation sequence by a second pronunciation prediction system, and/or correcting a third tone after tone sandhi in the first pronunciation sequence by a third pronunciation prediction system.

2. The method according to claim 1, wherein the predicting a first pronunciation sequence for the first text by a first pronunciation prediction system based on the first audio and the first text comprises:
predicting at least one pronunciation of each character in the first text by a first acoustics module in the first pronunciation prediction system based on the first audio, wherein a tone of the pronunciation comprises a neutral tone and/or a third tone after tone sandhi;
selecting, by a first decoding module in the first pronunciation prediction system and based on the first text, a first target pronunciation for each character in the first text from the at least one predicted pronunciation of the character in the first text; and
generating the first pronunciation sequence by the first decoding module based on the first target pronunciation.

3. The method according to claim 1, wherein the correcting a neutral tone in the first pronunciation sequence by a second pronunciation prediction system comprises:
predicting a second pronunciation sequence for the first text by the second pronunciation prediction system based on the first audio and the first text, wherein the second pronunciation sequence is used to label the tones of the pronunciations of the characters in the first text as neutral tones or non-neutral tones; and
correcting the neutral tone in the first pronunciation sequence based on the second pronunciation sequence.

4. The method according to claim 1, wherein the correcting a third tone after tone sandhi in the first pronunciation sequence by a third pronunciation prediction system comprises:
predicting a third pronunciation sequence for the first text by the third pronunciation prediction system based on the first audio and the first text, wherein the third pronunciation sequence is used to label the first third tone in the two consecutive third tones in the first text with a second tone; and
correcting the third tone after tone sandhi in the first pronunciation sequence based on the third pronunciation sequence.

5. The method according to claim 3, wherein the predicting a second pronunciation sequence for the first text by the second pronunciation prediction system based on the first audio and the first text comprises:
predicting, by a second acoustics module in the second pronunciation prediction system and based on the first audio, a probability that a tone of a pronunciation of each character in the first text is a neutral tone;
determining, by a second decoding module in the second pronunciation prediction system and based on the first text and the predicted probability that a tone of a pronunciation of each character in the first text is a neutral tone, that the tone of the pronunciation of each character in the first text is a neutral tone or a non-neutral tone; and
generating the second pronunciation sequence by the second decoding module based on a determination result.

6. The method according to claim 3, wherein the correcting the neutral tone in the first pronunciation sequence based on the second pronunciation sequence comprises:
determining whether a tone of a pronunciation of a first character in the first text in the first pronunciation sequence is labeled as a neutral tone or a non-neutral tone, wherein a tone of the pronunciation of the first character in the second pronunciation sequence is labeled as a neutral tone; and
in response to the tone of the pronunciation of the first character in the first pronunciation sequence being labeled as a neutral tone, keeping the tone of the pronunciation of the first character in the first pronunciation sequence unchanged; or
in response to the tone of the pronunciation of the first character in the first pronunciation sequence being labeled as a non-neutral tone, correcting the tone of the pronunciation of the first character in the first pronunciation sequence to a neutral tone.

7. The method according to claim 4, wherein the predicting a third pronunciation sequence for the first text by the third pronunciation prediction system based on the first audio and the first text comprises:
predicting at least one pronunciation of each character in the first text by a third acoustics module in the third pronunciation prediction system based on the first audio, wherein a tone of the pronunciation comprises a second tone corresponding to the first third tone in two consecutive third tones;
selecting, by a third decoding module in the third pronunciation prediction system and based on the first text, a second target pronunciation for each character in the first text from the at least one predicted pronunciation of each character in the first text; and
generating the third pronunciation sequence by the third decoding module based on the second target pronunciation.

8. The method according to claim 4, wherein the correcting the third tone after tone sandhi in the first pronunciation sequence based on the third pronunciation sequence comprises:
determining whether a tone of a pronunciation of a second character in the first text in the third pronunciation sequence is labeled as a second tone, wherein a tone of the pronunciation of the second character in the first pronunciation sequence is labeled as a third tone after tone sandhi; and
in response to the tone of the pronunciation of the second character in the first pronunciation sequence being labeled as a second tone, keeping the tone of the pronunciation of the second character in the first pronunciation sequence unchanged; or
in response to the tone of the pronunciation of the second character in the first pronunciation sequence not being labeled as a second tone, modifying the tone of the pronunciation of the second character in the first pronunciation sequence based on the tone of the pronunciation of the second character in the third pronunciation sequence.

9. The method according to claim 4, wherein the correcting the third tone after tone sandhi in the first pronunciation sequence based on the third pronunciation sequence comprises:
determining whether a tone of a pronunciation of a third character in the first text in the first pronunciation sequence is labeled as a third tone after tone sandhi, wherein a tone of the pronunciation of the third character in the third pronunciation sequence is labeled as a second tone corresponding to the first third tone in two consecutive third tones; and
in response to the tone of the pronunciation of the third character in the first pronunciation sequence being labeled as a third tone after tone sandhi, keeping the tone of the pronunciation of the third character in the first pronunciation sequence unchanged; or
in response to the tone of the pronunciation of the third character in the first pronunciation sequence not being labeled as a third tone after tone sandhi, modifying the tone of the pronunciation of the third character in the first pronunciation sequence to a third tone after tone sandhi.

10. The method according to claim 1, wherein the method further comprises:
obtaining first sample audio and a first sample pronunciation sequence corresponding to the first sample audio, wherein tones of pronunciations for the first sample audio in the first sample pronunciation sequence comprise neutral tones and/or third tones after tone sandhi; and the first third tone in two consecutive third tones for the first sample audio is labeled as a third tone after tone sandhi in the first sample pronunciation sequence;
determining a first time alignment relationship between each audio time frame in the first sample audio and each pronunciation in the first sample pronunciation sequence; and
training the first pronunciation prediction system based on the first time alignment relationship.

11. The method according to claim 3, wherein the method further comprises:
obtaining second sample audio and a second sample pronunciation sequence corresponding to the second sample audio, wherein the second sample pronunciation sequence is used to label a tone of each pronunciation for the second sample audio as a neutral tone or a non-neutral tone;
determining a second time alignment relationship between each audio time frame in the second sample audio and each pronunciation in the second sample pronunciation sequence; and
training the second pronunciation prediction system based on the second time alignment relationship.

12. The method according to claim 4, wherein the method further comprises:
obtaining third sample audio and a third sample pronunciation sequence corresponding to the third sample audio, wherein the first third tone in two consecutive third tones for the third sample audio is labeled as a second tone in the third sample pronunciation sequence;
determining a third time alignment relationship between each audio time frame in the third sample audio and each pronunciation in the third sample pronunciation sequence; and
training the third pronunciation prediction system based on the third time alignment relationship.

13. An electronic device, comprising:
a processor; and
a memory configured to store computer-executable instructions that, when executed, cause the processor to implement operations comprising:
obtaining first audio and first text corresponding to the first audio;
predicting a first pronunciation sequence for the first text by a first pronunciation prediction system based on the first audio and the first text, wherein tones of pronunciations of characters in the first text that are labeled in the first pronunciation sequence comprise neutral tones and/or third tones after tone sandhi; and the first third tone in two consecutive third tones in the first text is labeled as a third tone after tone sandhi in the first pronunciation sequence; and
correcting a neutral tone in the first pronunciation sequence by a second pronunciation prediction system, and/or correcting a third tone after tone sandhi in the first pronunciation sequence by a third pronunciation prediction system.

14. The electronic device according to claim 13, wherein the predicting a first pronunciation sequence for the first text by a first pronunciation prediction system based on the first audio and the first text comprises:
predicting at least one pronunciation of each character in the first text by a first acoustics module in the first pronunciation prediction system based on the first audio, wherein a tone of the pronunciation comprises a neutral tone and/or a third tone after tone sandhi;
selecting, by a first decoding module in the first pronunciation prediction system and based on the first text, a first target pronunciation for each character in the first text from the at least one predicted pronunciation of the character in the first text; and
generating the first pronunciation sequence by the first decoding module based on the first target pronunciation.

15. The electronic device according to claim 13, wherein the correcting a neutral tone in the first pronunciation sequence by a second pronunciation prediction system comprises:
predicting a second pronunciation sequence for the first text by the second pronunciation prediction system based on the first audio and the first text, wherein the second pronunciation sequence is used to label the tones of the pronunciations of the characters in the first text as neutral tones or non-neutral tones; and
correcting the neutral tone in the first pronunciation sequence based on the second pronunciation sequence.

16. The electronic device according to claim 13, wherein the correcting a third tone after tone sandhi in the first pronunciation sequence by a third pronunciation prediction system comprises:
predicting a third pronunciation sequence for the first text by the third pronunciation prediction system based on the first audio and the first text, wherein the third pronunciation sequence is used to label the first third tone in the two consecutive third tones in the first text with a second tone; and
correcting the third tone after tone sandhi in the first pronunciation sequence based on the third pronunciation sequence.

17. The electronic device according to claim 15, wherein the predicting a second pronunciation sequence for the first text by the second pronunciation prediction system based on the first audio and the first text comprises:
predicting, by a second acoustics module in the second pronunciation prediction system and based on the first audio, a probability that a tone of a pronunciation of each character in the first text is a neutral tone;
determining, by a second decoding module in the second pronunciation prediction system and based on the first text and the predicted probability that a tone of a pronunciation of each character in the first text is a neutral tone, that the tone of the pronunciation of each character in the first text is a neutral tone or a non-neutral tone; and
generating the second pronunciation sequence by the second decoding module based on a determination result.

18. The electronic device according to claim 15, wherein the correcting the neutral tone in the first pronunciation sequence based on the second pronunciation sequence comprises:
determining whether a tone of a pronunciation of a first character in the first text in the first pronunciation sequence is labeled as a neutral tone or a non-neutral tone, wherein a tone of the pronunciation of the first character in the second pronunciation sequence is labeled as a neutral tone; and
in response to the tone of the pronunciation of the first character in the first pronunciation sequence being labeled as a neutral tone, keeping the tone of the pronunciation of the first character in the first pronunciation sequence unchanged; or
in response to the tone of the pronunciation of the first character in the first pronunciation sequence being labeled as a non-neutral tone, correcting the tone of the pronunciation of the first character in the first pronunciation sequence to a neutral tone.

19. The electronic device according to claim 16, wherein the predicting a third pronunciation sequence for the first text by the third pronunciation prediction system based on the first audio and the first text comprises:
predicting at least one pronunciation of each character in the first text by a third acoustics module in the third pronunciation prediction system based on the first audio, wherein a tone of the pronunciation comprises a second tone corresponding to the first third tone in two consecutive third tones;
selecting, by a third decoding module in the third pronunciation prediction system and based on the first text, a second target pronunciation for each character in the first text from the at least one predicted pronunciation of each character in the first text; and
generating the third pronunciation sequence by the third decoding module based on the second target pronunciation.

20. A non-transitory computer-readable storage medium, for storing computer-executable instructions that, when executed by a processor, cause operations comprising:
obtaining first audio and first text corresponding to the first audio;
predicting a first pronunciation sequence for the first text by a first pronunciation prediction system based on the first audio and the first text, wherein tones of pronunciations of characters in the first text that are labeled in the first pronunciation sequence comprise neutral tones and/or third tones after tone sandhi; and the first third tone in two consecutive third tones in the first text is labeled as a third tone after tone sandhi in the first pronunciation sequence; and
correcting a neutral tone in the first pronunciation sequence by a second pronunciation prediction system, and/or correcting a third tone after tone sandhi in the first pronunciation sequence by a third pronunciation prediction system.
